(19) United States
(12) Patent Application Publication
(10) Pub. No.: US 2013/0001332 A1
(43) Pub. Date: Jan. 3, 2013

(54) ELECTRICALLY-POWERED SPREADER

(76) Inventor: Fred A. Marconi, JR., Erieville, NY (US)

(21) Appl. No.: 13/172,291

(22) Filed: Jun. 29, 2011

(51) Int. Cl. A01C 17/00; B65G 31/04; A01C 7/16

(52) U.S. Cl. 239/657; 239/684; 239/1

(57) ABSTRACT

An electrically-powered spreader for spreading a granular product is disclosed. The spreader may comprise a cap used to close a bottle containing the granular product. When in the open position, the bottle may be tilted into a position in which the granular product is fed by the force of gravity through an opening and into the spreader cap. A moving member within the spreader cap interacts with the granular product to propel it out of an opening in the spreader cap. In this way, the granular product is broadcast out of the bottle and onto the treatment area around the bottle.

### TECHNICAL FIELD OF THE INVENTION

The present disclosure generally relates to material handling and, more particularly, to an electrically-powered spreader for granular product.

### BACKGROUND OF THE INVENTION

In the field of horticulture, it is commonplace to spread granular adjuncts over surfaces to be treated. For example, grass seeds may be spread over lawns to initiate growth of grass in the treated area. Also, granular fertilizers may be spread in order to provide additional nutrients to the treated area. Likewise, granular pre-emergent herbicides may be spread over a planting area to prevent the germination of weed seeds in areas where desirable plants are already growing.

There are multiple methods known in the art for dispersing granular products onto treatment areas. In the simplest form, the product may be scooped into the user's hand and tossed over the treatment area. For larger treatment areas, it has been found useful to employ a device known as a broadcast spreader, which has rotating paddles driven through a gear mechanism by the spreader's ground wheels. When the spreader is pushed over the ground across the treatment area, the paddles are thereby caused to rotate. Product in the spreader's hopper falls onto the rotating paddles and is forced away from the spreader in a 360 degree treatment area.

Finally, some granular products are supplied in bottles having spouts at the top, and the bottle is simply turned and shaken, allowing the particles inside the bottle to emerge from the spout. The user performs this operation while directing the spout over the desired treatment area. As shown in FIG. 1, a prior art bottle 10 includes a cap 12 having a spout 14 that may be rotated from a closed position (not shown) to the open position shown in the figure. Granular product within the bottle is caused to exit opening 16. Vanes 18 are provided on the surface of the spout 14 that are operative to spread the granular product to either side of the spout 14 when the bottle and spout are moved from side to side by the user. Another prior art bottle 20 is illustrated in FIG. 2. Bottle 20 includes a cap 22 having a spout 24 that may be extended telescopically from a closed position (not shown) to the open position shown in the figure. Granular product within the bottle is caused to exit opening 26. Vanes 28 are provided on the surface of the spout 24 that are operative to spread the granular product to either side of the spout 24 when the bottle and spout are moved from side to side by the user. Another prior art bottle 30 is illustrated in FIG. 3. Bottle 30 includes a cap 32 having a spout 34 that may be rotated from a closed position (not shown) to the open position shown in the figure. Granular product within the bottle is caused to exit opening 36. Vanes 38 are provided on the surface of the spout 34 that are operative to spread the granular product to either side of the spout 34 when the bottle and spout are moved from side to side by the user.

All of the methodologies discussed above have drawbacks. Spreading product directly using the user's hands is inefficient, nearly impossible to execute in a manner that results in even spreading of the product, and can be dangerous if the product is of the type not intended for sustained contact with human skin. Broadcast spreaders are generally useful only for very large treatment areas, as it can be difficult to accurately control the area to which the product is applied. Furthermore, the broadcast spreader is relatively expensive and there is substantial overhead in setting the spreader up, filling and refilling the hopper, and then storing the spreader when not in use. Product that is supplied in bottles and shaken out of the spout offers the convenience of contained product and low overhead, but the act of shaking the product out of the bottle can very quickly cause fatigue to the user's hand and arm muscles.

Therefore, there remains a need for improvement in the art.

### SUMMARY OF THE INVENTION

An electrically-powered spreader for spreading a granular product is disclosed. The spreader may comprise a cap used to close a bottle containing the granular product. When in the open position, the bottle may be tilted into a position in which the granular product is fed by the force of gravity through an opening and into the spreader cap. A moving member within the spreader cap interacts with the granular product to propel it out of an opening in the spreader cap. In this way, the granular product is broadcast out of the bottle and onto the treatment area around the bottle.

In a first embodiment, an electrically-powered spreader adapted to be operably coupled to a container and operative to spread a quantity of granular product contained within the container comprises a dispensing portion, the dispensing portion defining a dispensing portion interior cavity, a first dispensing portion opening and a second dispensing portion opening; an impeller assembly disposed within the dispensing portion interior cavity; and a source of electrical energy operably coupled to the impeller assembly; wherein the electrical energy causes the impeller assembly to move, thereby propelling through the second dispensing portion opening at least a portion of the granular product entering the first dispensing portion opening.

In a second embodiment, an electrically-powered spreader adapted to be coupled to a container and operative to spread a quantity of granular product contained within the container comprises a base portion; a dispensing portion coupled to the base portion, the dispensing portion defining a dispensing portion interior cavity and a dispensing portion opening; a channel disposed between the base portion and the dispensing portion interior cavity, the channel adapted to receive a quantity of granular product therein and to direct the quantity of granular product to the dispensing portion interior cavity; an impeller assembly disposed within the dispensing portion interior cavity; and a source of electrical energy operably coupled to the impeller assembly; wherein the electrical energy causes the impeller assembly to move, thereby propelling through the dispensing portion opening at least a portion of the granular product entering the dispensing portion interior cavity from the channel.

In a third embodiment, an electrically-powered spreader comprises a container having a container interior adapted to hold a quantity of granular product, the container further having a container opening therein through which the granular product may pass; and a spreader cap, comprising: a base portion covering the container opening; a dispensing portion defining a dispensing portion interior cavity and a dispensing portion opening; a hinge rotatably coupling the base portion to the dispensing portion; a channel disposed between the base portion and the dispensing portion interior cavity; an impeller assembly disposed within the dispensing portion interior cavity; a switch operably coupled to the impeller assembly, the switch having at least a first position and a second position; and a source of electrical energy operably coupled to the switch; wherein placing the switch in the first position couples electrical energy to the impeller assembly, causing the impeller assembly to move, thereby propelling through the dispensing portion opening at least a portion of the granular product entering the dispensing portion interior cavity from the channel; and wherein placing the switch in the second position uncouples electrical energy from the impeller assembly, causing the impeller assembly to stop moving, thereby ceasing propelling granular product through the dispensing portion opening.

In a fourth embodiment, a method of spreading a quantity of granular product over a treatment area is disclosed, the method comprising the steps of: a) providing a container having a container interior to hold the quantity of granular product and a dispensing portion operatively coupled to the container, the dispensing portion having an electrically-powered impeller assembly; b) opening a channel between the container interior and the dispensing portion; c) activating the impeller assembly, thereby causing granular product to be dispensed from the dispensing portion; d) tilting the container to allow a portion of the quantity of granular product to flow through the channel and to the dispensing portion by the flow of gravity; and e) moving the container over the treatment area.

Other embodiments are also disclosed.

### BRIEF DESCRIPTION OF THE DRAWINGS

FIG. 1 is a schematic perspective view of a first prior art granular product dispensing bottle.

FIG. 2 is a schematic perspective view of a second prior art granular product dispensing bottle.

FIG. 3 is a schematic perspective view of a third prior art granular product dispensing bottle.

FIG. 4 is a perspective view of a first embodiment cap shown in the closed position.

FIG. 5 is a perspective view of the first embodiment cap shown in the open position.

FIG. 6 is an exploded perspective view of the first embodiment cap.

FIG. 7 is a bottom perspective view of an impeller of the first embodiment.

FIG. 8 is a bottom perspective view of one half of the dispenser portion of the first embodiment cap.

FIG. 9 is a bottom perspective view of one half of the dispenser portion of a second embodiment cap.

FIG. 10 is a bottom perspective view of one half of the dispenser portion of a third embodiment cap.

FIG. 11 is a schematic flow diagram of a first embodiment method of using the spreader caps disclosed herein.

### DETAILED DESCRIPTION OF VARIOUS EMBODIMENTS

For the purposes of promoting an understanding of the principles of the invention, reference will now be made to embodiments illustrated in the drawings, and specific language will be used to describe them. It will nevertheless be understood that no limitation of the scope of the invention is thereby intended. Alterations and modifications in the illustrated device, and further applications of the principles of the invention as illustrated therein, as would normally occur to one skilled in the art to which the invention relates, are contemplated.

As used in the present description and appended claims, the term “granular” refers to product that is composed of grains or granules. It is intended that “granular” encompass product that may be commonly described as “powdered,” as powdered product is merely granular product with a very small grain size.

The various embodiments of the present invention described below solve many of the problems that currently exist in the field of treating areas with granular product.

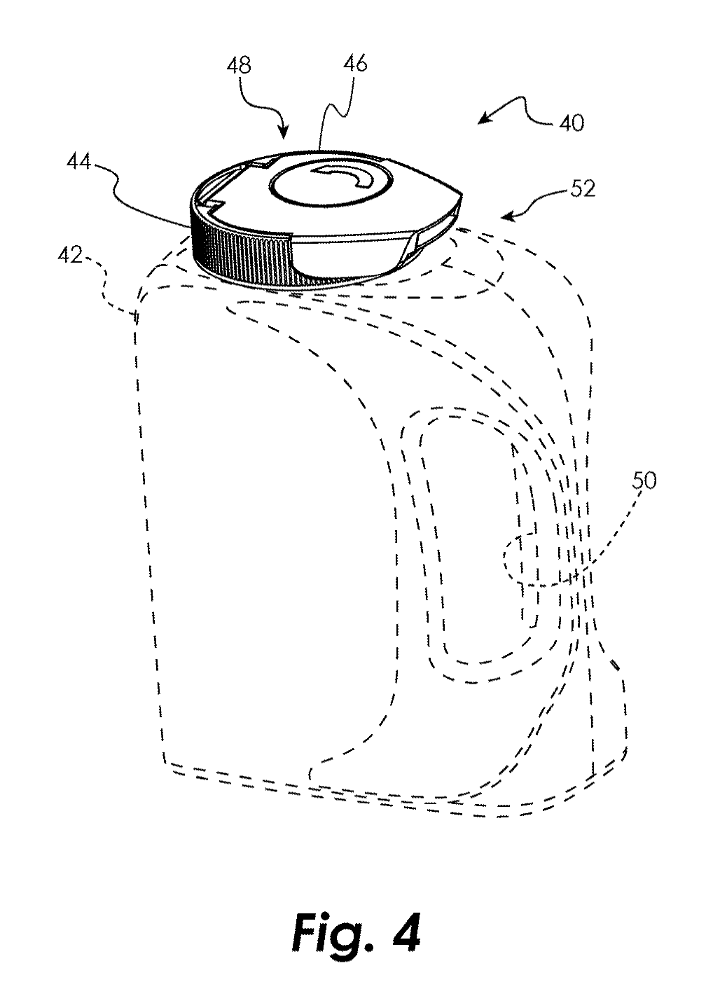

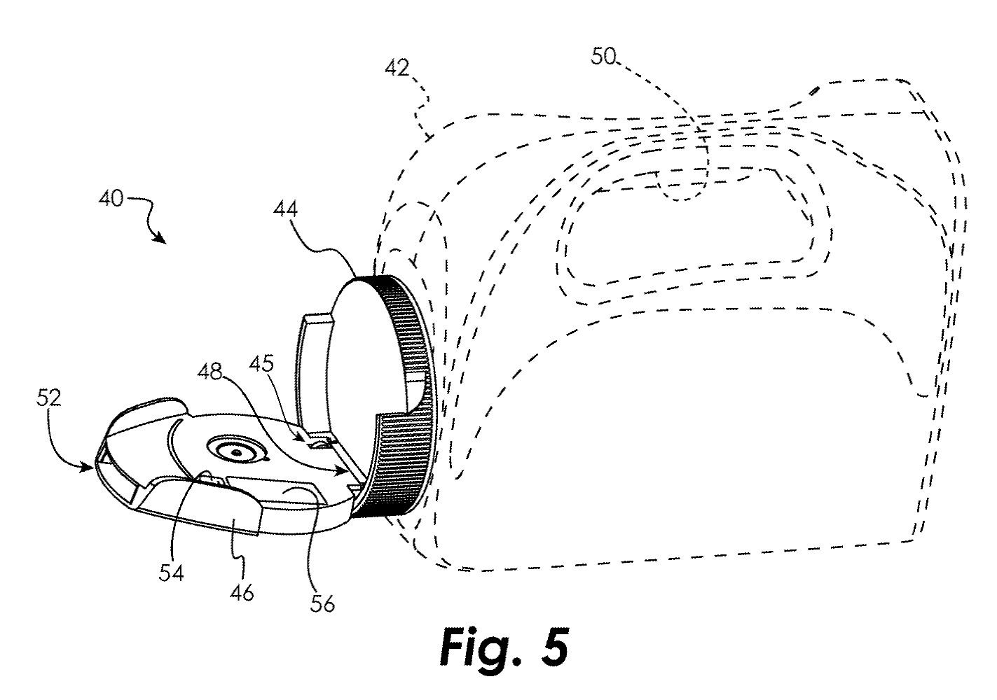

A first embodiment cap is illustrated in FIG. 4, and indicated generally at 40. Cap 40 fits onto a bottle 42 of any desired configuration in order to close an opening in said bottle 42. Although a plastic bottle 42 having a particular shape and configuration is illustrated in the drawings, those skilled in the art will appreciate that the presently disclosed embodiments will find application with bottles of varying designs, and manufactured from various materials, and the present invention is intended to encompass bottles of any configuration. Cap 40 is shown in the closed position in FIG. 4, where cap 40 prevents the granular content of the bottle 42 from escaping the bottle's opening (under cap 40, not shown). Cap 40 is shown in the open position in FIG. 5.

Cap 40 includes a base portion 44 that attaches to the bottle 42 and covers at least the opening in the bottle 42. Cap 40 may attach to bottle 42 by any removable or non-removable means, including ultrasonic welding, gluing, threaded connection and snap fit, just to name a few non-limiting examples. In some embodiments, the cap and bottle are one integrally formed piece.

In the illustrated embodiment, the cap 40 additionally includes a dispensing portion 46 coupled to the base portion 44 by means of a hinge 48. When in the closed position of FIG. 4, there is no opening between the interior of bottle 42 and the interior of the dispensing portion 46. When the hinge 48 is rotated to the open position shown in FIG. 5, a channel is opened between the interior of the bottle 42 and the interior of the dispensing portion 46, thereby allowing the flow of granular product within the bottle 42 into the dispensing portion 46 when the bottle 42 is tilted at the correct angle.

In some embodiments, the dispensing portion 46 does not move with respect to the base portion 44 (i.e., they are fixed in their relative positions with respect to one another). In such embodiments, a channel may be opened between the two portions by sliding a door or other obstruction that closes the channel when in a first position but opens the channel when in a second position. In other embodiments, the dispensing portion 46 moves with respect to the base portion 44, but the two pieces are not hinged together. For example, the dispensing portion 46 may move telescopically with respect to the base portion 44 in order to open a channel between the two for the flow of the granular product. In other embodiments, the dispensing portion 46 may be detached from the base portion 44 and then reattached in another position in order to open a channel between the two for the flow of the granular product. It will be appreciated that many other means for creating a channel between the two portions may be envisioned and that the means for creating a channel between the two portions is not critical. In some embodiments, the dispensing portion may be used without a base portion when the dispensing portion is used to cover the opening in a container and receives the granular product directly from a container.

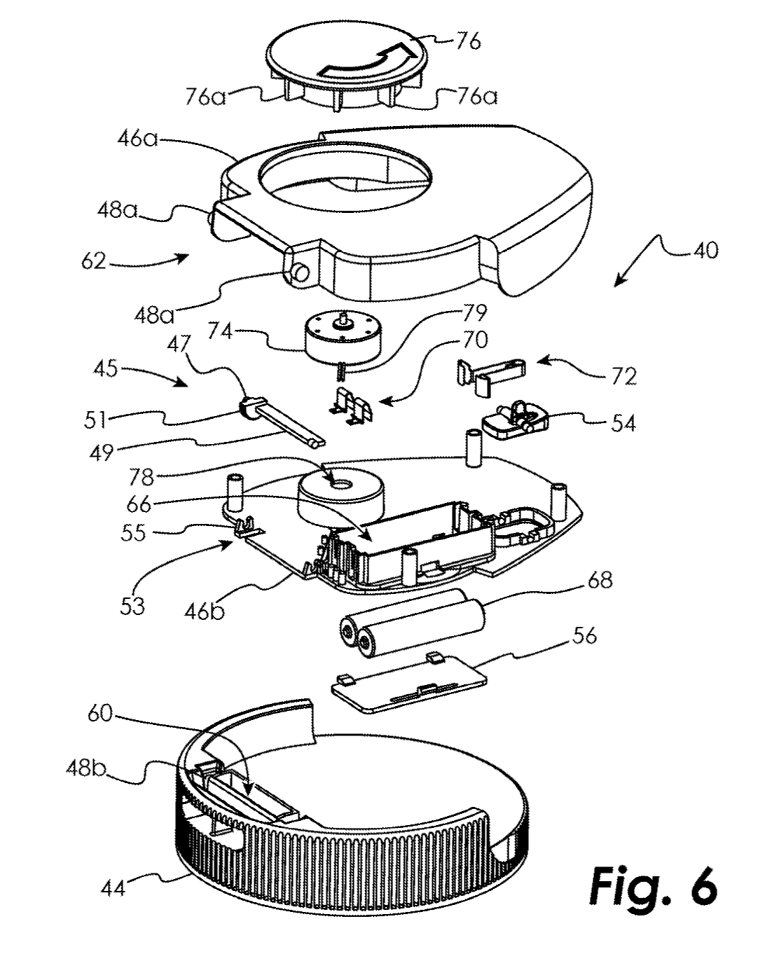

In other embodiments, the cap 40 includes a product feed adjustment control 45, located either on the dispensing portion 46 as shown in FIG. 5, or on base portion 44. The product feed adjustment control 45 is operative to allow the user to control the rate at which granular product is fed into the dispensing portion 46 from the bottle 42. One embodiment of the product feed adjustment control 45 is discussed hereinbelow with respect to FIG. 6, but those skilled in the art will recognize from this disclosure that many other means for rating flow of the granular product from the bottle 42 to the dispensing portion 46 may be envisioned. Examples include, but are not limited to, a sliding door allowing the width or height of the channel between the bottle 42 and the dispensing portion 46 to be adjusted, an adjustable iris mechanism in the channel, a conical stopper at the channel opening, the translation of which within the channel adjusts the area of the opening of the channel, etc.

In the embodiment illustrated in FIGS. 4 and 5, the bottle 42 includes a handle 50 that is oriented in such a manner that when the bottle 42 is positioned in a manner to allow granular product within the bottle 42 to flow into the interior of the dispensing portion 46 by means of gravity flow, the handle 50 is positioned to allow the bottle 42 to be carried comfortably by the user, such as being positioned on the top of the bottle 42 when the bottle 42 is placed in this position. Such placement of the handle 50 provides for an ergonomic use of the bottle 42 when product is being dispensed.

Once the granular product enters the interior of the dispensing portion 46, it is engaged by a moving member within the dispensing portion 46, as described in greater detail hereinbelow, which interacts with the granular product to propel the granular product out of an opening 52 in the dispensing portion 46. The moving member may be activated and deactivated by use of a switch 54 placed in a suitable location, such as on the dispensing portion 46 to name just one non-limiting example. It will be appreciated that placement of the switch 54 on the side of the dispensing portion 46 that is not exposed when the dispensing portion 46 is in the closed position prevents accidental activation of the moving member since the switch 54 is protected from unintended contact. Those skilled in the art will recognize that the switch 54 may be placed in any other convenient location, such as on the base portion 44, the bottle 42, or the handle 50, to name just a few non-limiting examples. A battery compartment cover 56 is provided on the dispensing portion 46 for ease in changing the batteries that are used to power the propulsion system, as described in greater detail hereinbelow.

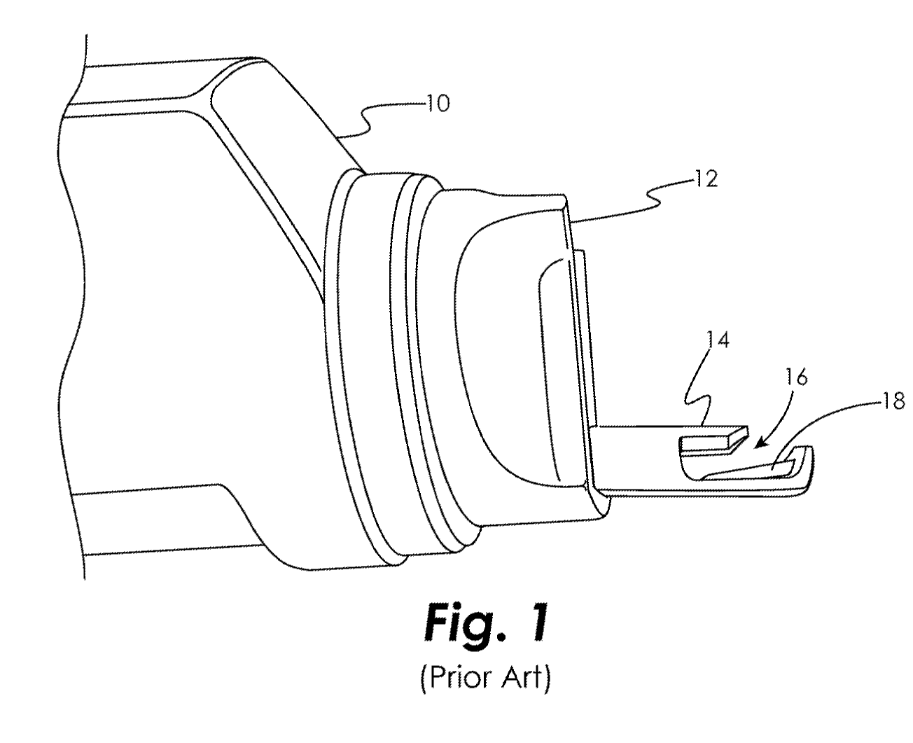

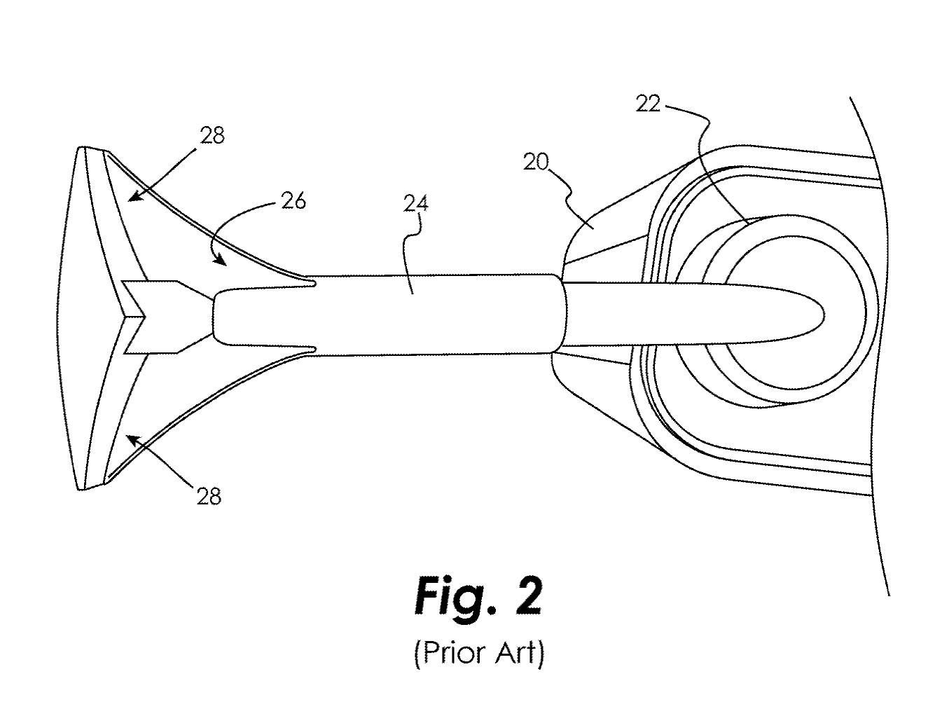

It will be appreciated that the cap 40/bottle 42 combination represents a substantial improvement over the prior art, particularly the prior art devices of FIGS. 1-3 that must be shaken back and forth in order to dispense product over the treatment area. With the embodiment of FIGS. 4-5, the user simply opens the dispensing portion 46, toggles the switch 54 to activate the moving member, and tilts the bottle 42 to a position that allows the granular product therein to flow into the dispensing portion 46 by the force of gravity. The action of the moving member within the dispensing portion 46 will then impel the granular product out through the opening 52. Because the bottle 42 does not have to be moved (other than tilting it into the dispensing position), not only are the user's hand and arm muscles less likely to become fatigued through constant motion, but the ability to carefully direct the application of the product onto the treatment area with increased accuracy is greatly enhanced.

The first embodiment cap 40 is illustrated in an exploded perspective view in FIG. 6. Visible within the base portion 44 is a channel 60 that allows granular product to flow from the interior of the bottle 42 and into the cap 40. Dispensing portion 46 may be formed from a first dispensing portion half 46a and a second dispensing portion half 46b. First dispensing portion half 46a and second dispensing portion half 46b are coupled together to form an internal cavity into which granular product flowing through the channel 60 enters by means of a gap 62 between the first dispensing portion half 46a and a second dispensing portion half 46b. Such coupling may be by any convenient means, such as by the screws, by a snap fit, ultrasonic welding, gluing, or by any other convenient means as will be appreciated by those skilled in the art. The hinge 48 may be formed in one embodiment by the round protrusions 58a and 58b which mate with respective indentations 48b (one of which is visible in FIG. 6) formed in the base portion 44. Other hinge arrangements will be apparent to those skilled in the art. Rotating the hinge 48 to the closed position causes the channel 60 to be covered by the second dispensing portion half 46b.

The battery cover 56 covers a battery compartment 66 formed in the second dispensing portion half 46b for carrying one or more batteries 68. Those skilled in the art will recognize that other sources of electrical energy may be used in place of batteries, such as solar cells. Conductive contacts 70, 72 within the battery compartment 66 couple the positive and negative terminals of the batteries 68. The switch 54 selectably couples the batteries 68 to an impeller assembly in order to turn the powered spreader cap 40 on and off. The product feed adjustment control 45 includes a mounting extension 47, a paddle 49, and a thumbwheel 51 that extends through an opening 53 in the second dispensing portion half 46b. The mounting extension 47 snaps into the mount 55 which retains the product feed adjustment control 45 while allowing rotation thereof. It will be appreciated that rotation of the thumbwheel 51 by the user will cause the paddle 49 to rotate such that its broad side moves into or out of the flow of granular product flowing in the channel 60. By this means, the rate at which granular product is allowed to flow through the channel 60, and hence the rate at which granular product is dispensed by the cap 40, may be controlled by the user. It will also be appreciated that while the paddle 49 is shown extending in one direction from the product feed adjustment control 45 axis of rotation, the paddle 49 may extend in multiple directions therefrom, such as two, three, four, etc. directions.

In the embodiment of FIG. 6, the impeller assembly comprises an electric motor 74 and a rotary fan blade impeller 76. The motor 74 mounts within a cavity 78 formed within the second dispensing portion half 46b, and the impeller 76 mounts over and encloses the cavity 78. The motor 74 is coupled to the impeller 76 in order to cause the impeller 76 to rotate when the motor 74 is turned on by activation of the switch 54. The motor 74 is electrically coupled to the switch 54 by means of conductors 79.

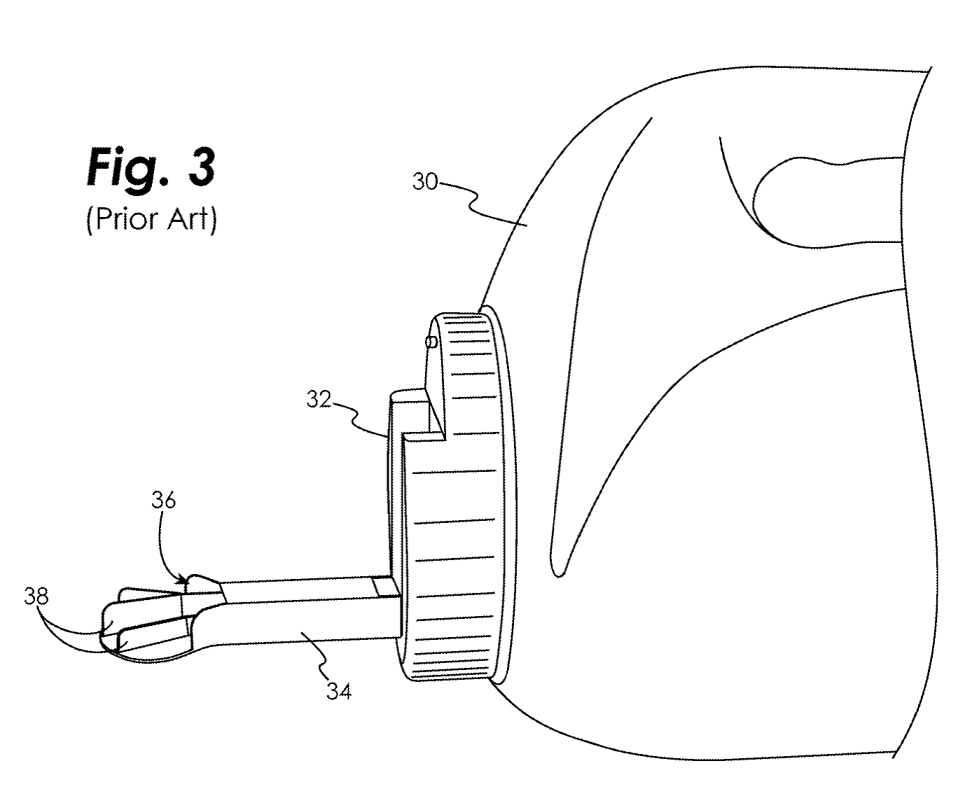

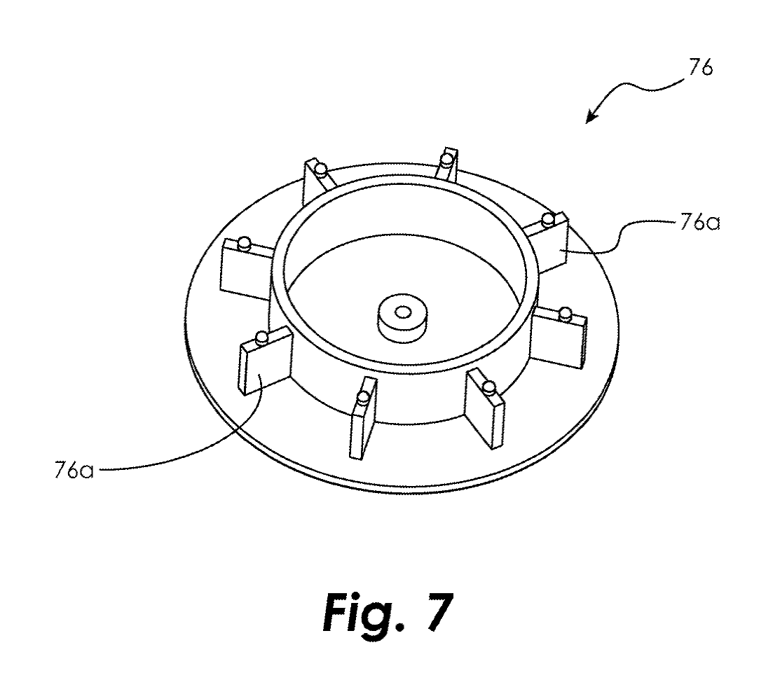

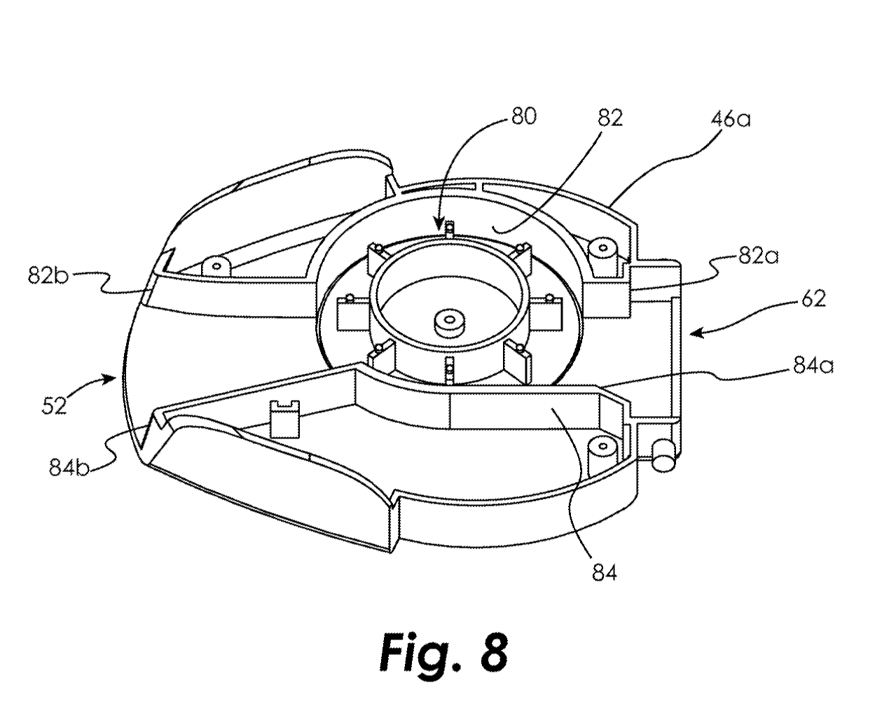

The rotary fan blade impeller 76 includes a plurality of blades 76a (see also FIG. 7). With reference to FIG. 8, structures on the underside of first dispenser portion half 46a create a cavity 80 into which the granular product flows from gap 62, where it reacts with the impeller assembly and is forced out of the opening 52. Walls 82 and 84 define the cavity 80. Proximal ends 82a and 84a of the walls 82 and 84 align with the channel 60, thereby confining flow of the granular product to the cavity 80 where the granular product is contacted by the rotating blades 76a and forced out of the opening 52. A plurality of vanes 86 may be used to direct the flow of granular product in desired directions. It will be appreciated that the distal ends 82b and 84b of the walls 82 and 84 serve as vanes to direct the flow of granular product in desired directions. Additionally, one or more vanes (not shown) analogous to the vanes 38 of FIG. 3 may be added between the distal ends 82b and 84b of the walls 82 and 84 to direct the granular product direction.

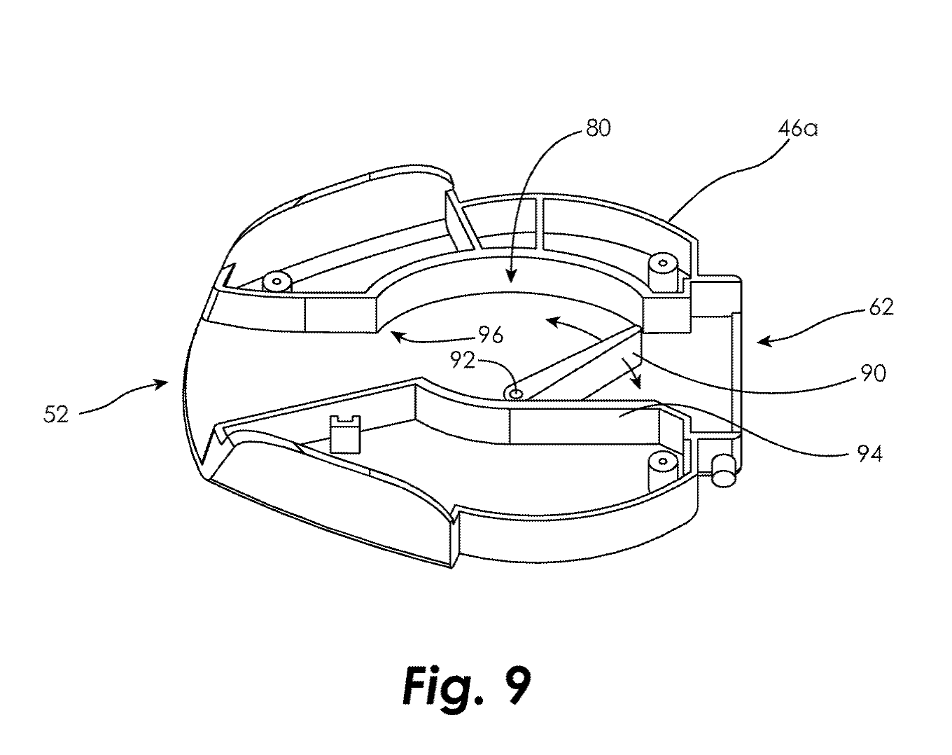

FIG. 9 illustrates a second embodiment impeller assembly comprising a blade 90 that pivots upon a shaft 92. The blade 90 is made to alternately pivot around the shaft 92 in a counter-clockwise direction and a clockwise direction, similar in fashion to a wiper blade on an automobile windshield. The blade 90 pivots from the point 94 to the point 96 before returning to the point 94 to begin the cycle once again. In this manner, the impeller blade 90 continuously sweeps granular product that is entering the cavity 80 at opening 62 toward the opening 52.

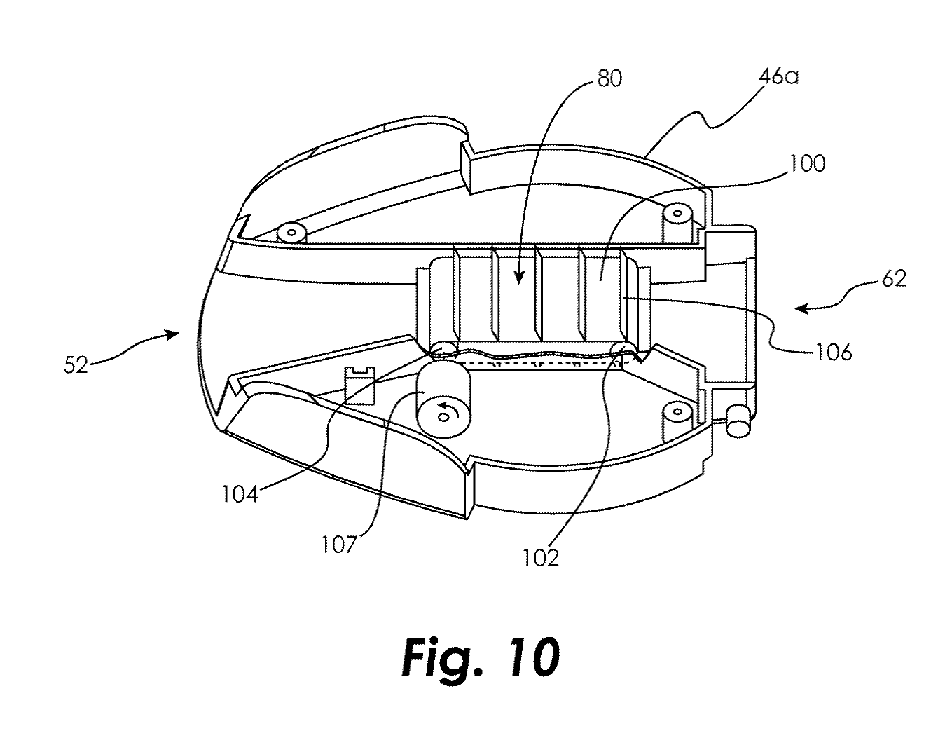

FIG. 10 illustrates a third embodiment impeller assembly comprising a continuous track 100 riding upon wheels 102 and 104. Mounted at intervals upon the track 100 are impeller vanes 106. It will be noted that in the third embodiment the cavity 80 is not circularly shaped, but rather elongated. The wheel 104 is made to rotate by a convenient means, such as by motor 107, thereby rotating the track 100 and the impeller vanes 106. In this manner, the impeller vanes 106 continuously sweep granular product that is entering the cavity 80 at opening 62 toward the opening 52. Those skilled in the art will recognize that other powered impeller assemblies operative to drive granular product toward the opening 52 may be constructed, the particular construction of the powered impeller assembly not being critical.

It will be appreciated by those skilled in the art that the container holding the granular product and the spreader cap may be separated from one another and connected by an appropriate conduit for the flow of granular product (i.e., an extension of the channel 60). For example, the container holding the granular product may be worn as a backpack or shoulder-carried container, and the channel 60 may comprise an elongated flexible tube that couples the container to the cap 40. In such embodiments, the granular product is carried through the tube by the force of gravity and enters the cap 40, where the impeller assembly propels the granular product out of the opening 52. Other analogous arrangements of the container and spreader are also contemplated by the appended claims.

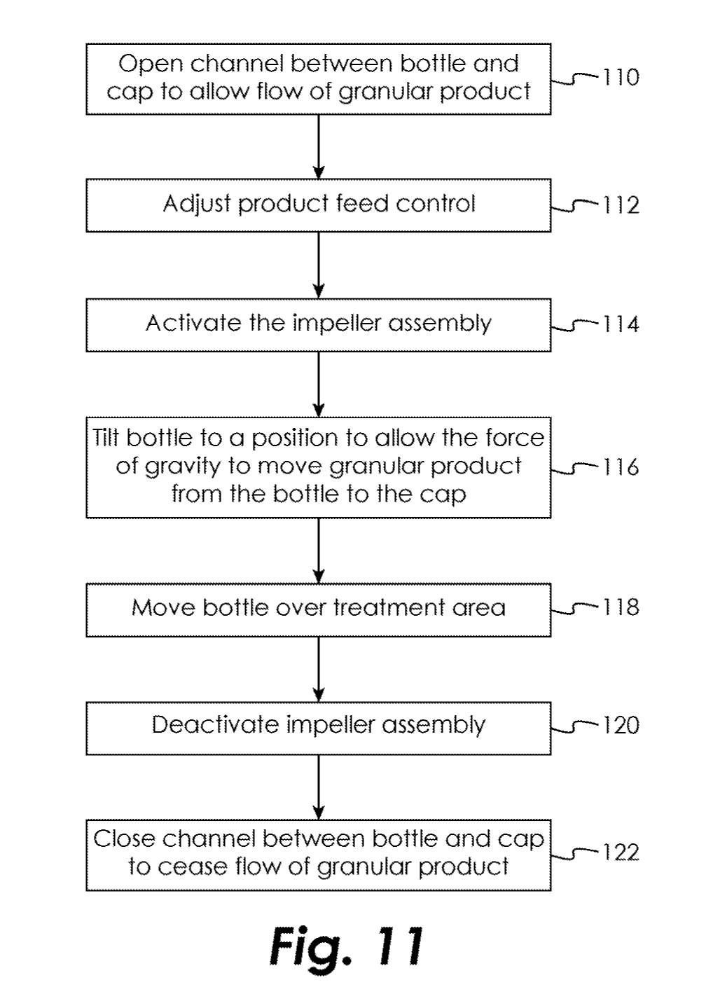

A first embodiment method of using the powered spreader caps disclosed herein is illustrated schematically in FIG. 11. First, a channel is opened between the bottle and the spreader cap in order to allow flow of granular product from the bottle to the cap (step 110). The product feed control may be adjusted to control the rate at which granular product is fed into the spreader (step 112). The impeller assembly within the cap is then activated by coupling electrical power to the impeller assembly (step 114). The bottle is then tilted to a position that will allow the force of gravity to move granular product from the interior of the bottle into the interior of the cap through the channel (step 116). With the impeller assembly activated and granular product flowing into the cap by force of gravity, granular product will be propelled out of the cap's opening and the user can begin moving the bottle over the treatment area to spread the granular product in the desired manner (step 118). When the treatment area has been satisfactorily treated with granular product, the impeller assembly is deactivated by removing electrical power therefrom (step 120). This will stop the flow of granular product from the opening in the cap. The channel between the bottle and the cap may then be closed in order to store the granular product (step 122). In some embodiments, the bottle is tilted back to its starting position prior to closing the channel in order to allow any excess granular product within the cap to drain back into the bottle.

While the invention has been illustrated and described in detail in the drawings and foregoing description, the description is meant to be illustrative, and not restrictive in character. Only the preferred embodiments, and certain alternative embodiments deemed useful for further illuminating the preferred embodiments, have been shown and described. All changes and modifications that come within the spirit of the invention are desired to be protected.

What is claimed is:

1. An electrically-powered spreader adapted to be operably coupled to a container and operative to spread a quantity of granular product contained within the container, the spreader comprising:
a dispensing portion, the dispensing portion defining a dispensing portion interior cavity, a first dispensing portion opening and a second dispensing portion opening;
an impeller assembly disposed within the dispensing portion interior cavity; and
a source of electrical energy operably coupled to the impeller assembly;
wherein the electrical energy causes the impeller assembly to move, thereby propelling through the second dispensing portion opening at least a portion of the granular product entering the first dispensing portion opening.

2. The spreader of claim 1, further comprising a base portion coupled to the dispensing portion.

3. The spreader of claim 2, wherein the base portion includes a threaded surface.

4. The spreader of claim 2, further comprising a channel disposed between the base portion and the dispensing portion interior cavity, the channel adapted to receive a quantity of granular product therein and to direct the quantity of granular product to the first dispensing portion opening.

5. The spreader of claim 2, further comprising:
a hinge rotatably coupling the base portion to the dispensing portion.

6. The spreader of claim 4, further comprising:
a hinge rotatably coupling the base portion to the dispensing portion.

7. The spreader of claim 6, wherein the channel is closed when the hinge is rotated to a first position.

8. The spreader of claim 1, further comprising:
at least one vane within the dispensing portion interior cavity, the at least one vane configured to deflect the granular product propelled by the impeller assembly in at least one direction.

9. The spreader of claim 1, further comprising:
a switch operably coupled between the impeller assembly and the source of electrical energy and operative to connect and disconnect the source of electrical energy and the impeller assembly.

10. The spreader of claim 9, wherein the switch is disposed on the dispensing portion.

11. The spreader of claim 1, wherein the impeller assembly comprises:
a rotary impeller;
at least one blade disposed on the rotary impeller; and
an electric motor operably coupled to the rotary impeller;
wherein the rotary impeller is caused to rotate when the electric motor is caused to rotate.

12. The spreader of claim 1, wherein the source of electrical energy comprises at least one battery.

13. The spreader of claim 12, wherein the at least one battery is disposed in the dispensing portion.

14. The spreader of claim 1, further comprising a product feed adjustment control operative to limit an amount of granular product entering the dispensing portion.

15. An electrically-powered spreader adapted to be coupled to a container and operative to spread a quantity of granular product contained within the container, the spreader comprising:
a base portion;
a dispensing portion coupled to the base portion, the dispensing portion defining a dispensing portion interior cavity and a dispensing portion opening;
a channel disposed between the base portion and the dispensing portion interior cavity, the channel adapted to receive a quantity of granular product therein and to direct the quantity of granular product to the dispensing portion interior cavity;
an impeller assembly disposed within the dispensing portion interior cavity; and
a source of electrical energy operably coupled to the impeller assembly;
wherein the electrical energy causes the impeller assembly to move, thereby propelling through the dispensing portion opening at least a portion of the granular product entering the dispensing portion interior cavity from the channel.

16. The spreader of claim 15, wherein the base portion includes a threaded surface.

17. The spreader of claim 15, further comprising:
a hinge rotatably coupling the base portion to the dispensing portion.

18. The spreader of claim 17, wherein the channel is closed when the hinge is rotated to a first position.

19. The spreader of claim 15, further comprising:
at least one vane within the dispensing portion interior cavity, the at least one vane configured to deflect the granular product propelled by the impeller assembly in at least one direction.

20. The spreader of claim 15, further comprising:
a switch operably coupled between the impeller assembly and the source of electrical energy and operative to connect and disconnect the source of electrical energy and the impeller assembly.

21. The spreader of claim 20, wherein the switch is disposed on the dispensing portion.

22. The spreader of claim 15, wherein the impeller assembly comprises:
a rotary impeller;
at least one blade disposed on the rotary impeller; and
an electric motor operably coupled to the rotary impeller;
wherein the rotary impeller is caused to rotate when the electric motor is caused to rotate.

23. The spreader of claim 15, wherein the source of electrical energy comprises at least one battery.

24. The spreader of claim 23, wherein the at least one battery is disposed in the dispensing portion.

25. The spreader of claim 15, further comprising a product feed adjustment control operative to limit an amount of granular product entering the dispensing portion.

26. An electrically-powered spreader, comprising:
a container having a container interior adapted to hold a quantity of granular product, the container further having a container opening therein through which the granular product may pass; and
a spreader cap, comprising:
a base portion covering the container opening;
a dispensing portion defining a dispensing portion interior cavity and a dispensing portion opening;
a hinge rotatably coupling the base portion to the dispensing portion;
a channel disposed between the base portion and the dispensing portion interior cavity;
an impeller assembly disposed within the dispensing portion interior cavity;
a switch operably coupled to the impeller assembly, the switch having at least a first position and a second position; and
a source of electrical energy operably coupled to the switch;
wherein placing the switch in the first position couples electrical energy to the impeller assembly, causing the impeller assembly to move, thereby propelling through the dispensing portion opening at least a portion of the granular product entering the dispensing portion interior cavity from the channel; and
wherein placing the switch in the second position uncouples electrical energy from the impeller assembly, causing the impeller assembly to stop moving and thereby to cease propelling granular product through the dispensing portion opening.

27. The spreader of claim 26, further comprising:
a handle disposed on the container;
wherein granular product within the container flows out of the container opening by the force of gravity when the container is held by the handle by a user.

28. The spreader of claim 26, wherein the base portion is coupled to the container by a threaded connection.

29. The spreader of claim 26, further comprising:
at least one vane within the dispensing portion interior cavity, the at least one vane configured to deflect the granular product propelled by the impeller assembly in at least one direction.

30. The spreader of claim 26, wherein the channel is closed when the hinge is rotated to a first position.

31. The spreader of claim 26, wherein the impeller assembly comprises:
a rotary impeller;
at least one blade disposed on the rotary impeller; and
an electric motor operably coupled to the rotary impeller;
wherein the rotary impeller is caused to rotate when the electric motor is caused to rotate.

32. The spreader of claim 26, wherein the switch is disposed on the dispensing portion.

33. The spreader of claim 26, wherein the source of electrical energy comprises at least one battery.

34. The spreader of claim 33, wherein the at least one battery is disposed in the dispensing portion.

35. The spreader of claim 26, further comprising a product feed adjustment control operative to limit an amount of granular product entering the dispensing portion.

36. A method of spreading a quantity of granular product over a treatment area, the method comprising the steps of:
a) providing a container having a container interior to hold the quantity of granular product and a dispensing portion operatively coupled to the container, the dispensing portion having an electrically-powered impeller assembly;
b) opening a channel between the container interior and the dispensing portion;
c) activating the impeller assembly, thereby causing granular product to be dispensed from the dispensing portion;
d) tilting the container to allow a portion of the quantity of granular product to flow through the channel and to the dispensing portion by the flow of gravity; and
e) moving the container over the treatment area.

37. The method of claim 36, further comprising the steps of:
f) deactivating the impeller assembly; and
g) closing the channel between the container interior and the dispensing portion.
